(19) United States
(12) Patent Application Publication
(10) Pub. No.: US 2002/0090246 A1
(43) Pub. Date: Jul. 11, 2002

(54) Printer with output option unit coupled to input option unit

(76) Inventors: Christopher Lee Baker, Salvisa, KY (US); Daniel Paul Cahill, Verona, KY (US); Edward Alan Rush, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/750,224

(22) Filed: Jan. 9, 2001

(51) Int. Cl. B41J 11/58; B41J 13/10; B41J 3/39; B41J 29/02; B41J 29/12

(52) U.S. Cl. 400/693; 400/624; 400/691

(57) ABSTRACT

A printer fir printing on a print medium includes a base unit with a primary media supply tray. An input option unit is positioned below the primary media supply tray. An output option unit is coupled with the input option unit.

### BACKGROUND OF THE INVENTION

1. Field of the invention.

The present invention relates to printers for printing on a print medium, and, more particularly, to printers which include optional input option units and output option units.

2. Description of the related art.

A printer for printing on a print medium typically includes a primary media supply tray and an output tray. As part of an overall system, it is also possible to include one or more input option units and one or more output option units in conjunction with the base unit. The input option units are typically in the form of media supply trays, and the output option units are typically in the form of a stacker, stapler, hole puncher and/or offset jogger.

It is known to place the input option units and the output option units on opposite sides of the base machine. In this manner, the base unit, optional input units and optional output units may be assembled from a common reference plane, namely the horizontal support surface such as a floor upon which they are placed.

It is also known to position the input option units beneath the base unit, rather than to the side of the base unit. If multiple input option units are utilized, the vertical dimensional tolerance stack-up may exceed acceptable levels which may cause the output from the base unit to vary from the input position of an output option unit. If the output of the base unit does not properly align with the input to the output option unit, the paper may not be properly discharged to the output option unit.

What is needed in the art is a printer having an output option unit and one or more input option units which are coupled with a base unit in a manner such that dimensional tolerance stack-ups are reduced.

### SUMMARY OF THE INVENTION

The present invention provides a printer for printing on a print medium which includes an output option unit, such as a stacker, stapler, hole puncher and/or off-set jogger, which is coupled with and/or carried by at least one input option unit, such as a print media supply tray.

The invention comprises, in one form thereof, a printer for printing on a print medium. A base unit includes a primary media supply tray. An input option unit is positioned below the primary media supply tray. An output option unit is coupled with the input option unit.

An advantage of the present invention is that the output option unit is coupled with and carried by an input option unit, thereby reducing tolerance stack-up errors which might exist if the output option unit is coupled with and carried by the base unit of the printer.

Another advantage is that the output option unit may be coupled with and carried by one or more input option units in a detachable or fixed manner.

Yet another advantage is that the output option unit may be coupled with an input option unit using a plurality of mounting beams.

A still further advantage is that multiple input option units may be keyed and located relative to each other and to the base unit using integral keying features.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a plan view of an embodiment of a printer of the present invention;

FIG. 2 is a plan view of the input option unit and output option unit of the printer of FIG. 1;

FIG. 3 is a perspective view of the input option unit and output option unit shown in FIGS. 1 and 2; and

FIG. 4 is a perspective view of the input option unit and output option unit shown in FIGS. 1-3, in a disassembled state.

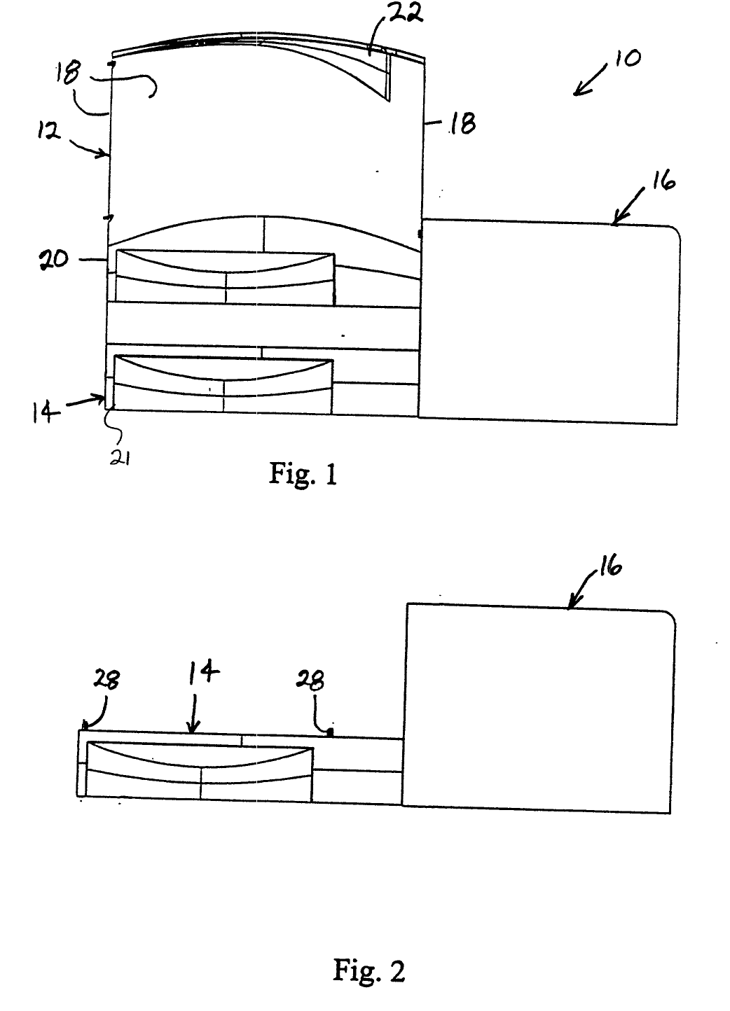

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Referring now to the drawings, there is shown an embodiment of a printer 10 for printing on a print medium (not shown). Printer 10 generally includes a base unit 12, an input option unit 14 and an output option unit 16.

Base unit 12 includes a plurality of side walls 18 which house a print engine (not shown) therein. The print engine may be configured, e.g., such that printer 10 is in the form of an electrophotographic printer or an ink jet printer. An output tray 22 is positioned at the top of base unit 12, and a primary media supply tray 20 is positioned at the bottom of base unit 12. Thus, base unit 12, including output tray 22 and primary media supply tray 20, defines a base printer unit which may be sold to a purchaser.

Printer 10 includes a single input option unit 14 in the embodiment shown, but may include multiple input option units arranged in a vertically stacked relationship relative to each other below primary media supply tray 20. For simplicity sake, only a single input option unit 14 in the form of a media supply tray is shown in the drawings. Media supply tray 14 may be suitably configured to accommodate a single size or multiple different sizes of print media, depending upon the particular application. Media supply tray 14 includes a drawer 21 which is removably installed therein for the purposes of loading and unloading print media.

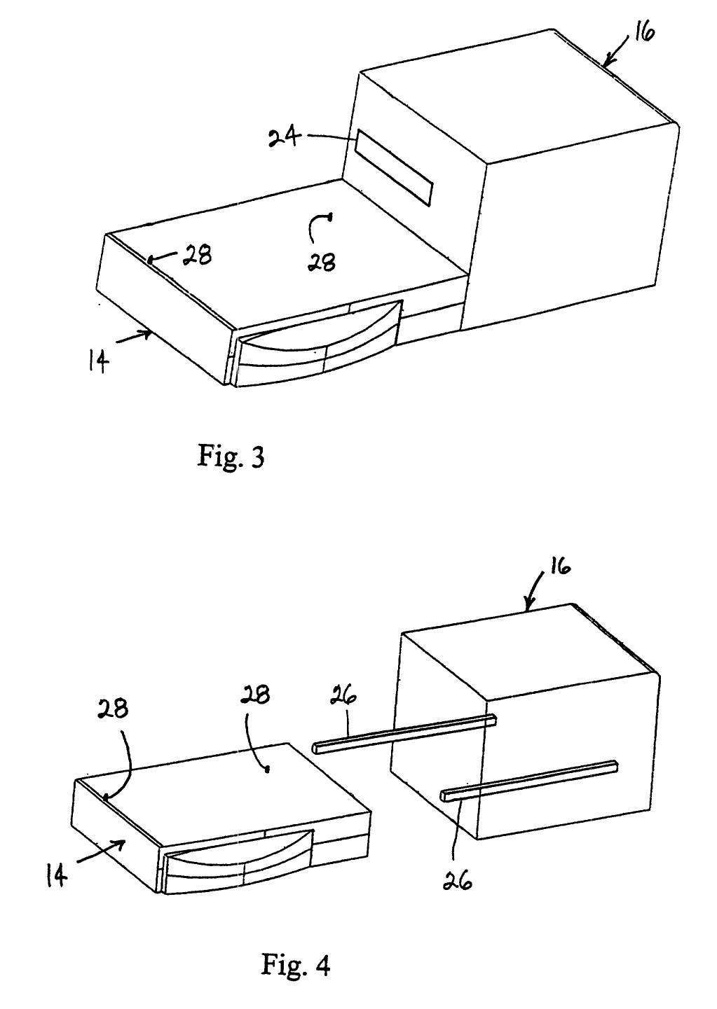

Output option unit 16 is positioned adjacent to one of the side walls 18 of base unit 12. In the embodiment shown, output option unit 16 is in the form of a stacker having an input slot 24 (FIG. 3). However, output option unit 16 may also be configured to include a stapler, hole puncher and/or offset jogger. The capacity of output option unit 16 may also be sized relative to the number of media supply trays, or may include multiple output option units, depending upon the particular application.

According to an aspect of the present invention, output option unit 16 is coupled with and carried by input option unit 14, rather than base unit 12. Output option unit 16 is preferably coupled with and carried by the input option unit 14 which is immediately below base unit 12. In this manner, tolerance stack-up errors which may affect the discharge of paper into input slot 24 of output option unit 16 may be reduced. Generally speaking, the capacity of output option unit 16 is matched to the capacity of primary media supply tray 20 and optional input media supply tray 14. In the embodiment shown, primary media supply tray 20 and optional input media supply tray 14 each have a 500 sheet capacity. Thus, output option unit 16 has a capacity of 1000 sheets to match the combined capacity of primary media supply tray 20 and optional input media supply tray 14.

Depending upon the particular application, it may also be desirable or necessary to attach output option unit 16 to an input option unit 14 which is not immediately adjacent to base unit 12 and/or attach output option unit 16 to multiple input option units positioned below base unit 12. However, in order to reduce dimensional tolerance stack-up errors, it is preferable to attach output option unit 16 to input option unit 14 positioned immediately below and adjacent to base unit 12.

Output option unit 16 may be coupled with input option unit 14 in either a fixed or detachable manner using any of a number of different attachment techniques. Detachable coupling between output option unit 16 and input option unit 14 allows output option unit 16 to be removed in the event of paper jams, etc. In the embodiment shown, output option unit 16 is coupled with input option unit 14 using a pair of mounting beams 26 (FIG. 4). Mounting beams 26 extend into each of output option unit 16 and input option unit 14 a sufficient distance to ensure adequate coupling and reduce relative movement therebetween. Mounting beams 26 may be adhesive bonded, welded, fastened, etc. to input option unit 14 and output option unit 16, depending upon the particular application.

Input option unit 14 includes a plurality of keying features which allow input option unit 14 to be properly located relative to base unit 12. In the embodiment shown, input option unit 14 includes two keying features in the form of keying posts 28 which extend vertically upwards toward the bottom side of base unit 12. Keying posts 28 are received within corresponding recesses formed in the bottom of base unit 12 so that input option unit 14 is properly located relative to base unit 12.

To assemble printer 10, a selected number of input option units are arranged in a vertically stacked relationship relative to each other below base unit 12. Each input option unit preferably includes a plurality of keying features 28 which allow proper positioning relative to base unit 12 and/or input option units positioned above and/or below. Each of the input option units are thus properly located relative to base unit 12. However, in spite of proper positioning using keying features 28, the vertical dimensional tolerance stack-up errors associated with a multiple number of input option units 14 can exceed desired amounts. Output option unit 16 is sized corresponding to the number of input option units 14 positioned below base unit 12. Thus, if the number of print media sheets in primary media supply tray 20 and the total number of input option units 14 totals 2000, then output option unit 16 is sized with a 2000 sheet capacity in the case of a stacker. To avoid dimension tolerance stack-up errors associated with the number of input option units 14, output option unit 16 is preferably coupled with and carried by input option unit 14 positioned immediately below base unit 12. In this manner, the only vertical tolerance error is the tolerance between the upper most input option unit 14 and base unit 12, which typically is acceptable from a manufacturing and operating perspective.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A printer for printing on a print medium, said printer comprising:
a base unit;
at least one input option unit, each said input option unit coupled with at least one of said base unit and another said input option unit; and
an output option unit coupled with at least one said input option unit.

2. The printer of claim 1, said base unit including a primary media supply tray, each said input option unit positioned below said primary media supply tray.

3. The printer of claim 2, said at least one input option unit comprising a plurality of input option units arranged in a vertically stacked relationship to each other.

4. The printer of claim 1, said base unit including a plurality of side walls, said output option unit positioned adjacent to one of said side walls.

5. The printer of claim 1, said output option unit coupled with a single said input option unit.

6. The printer of claim 1, said output option unit coupled with said at least one input option unit via a plurality of mounting beams.

7. The printer of claim 6, said mounting beams being one of detachably mounted and fixedly mounted to said output option unit.

8. The printer of claim 6, said mounting beams being one of detachably mounted and fixedly mounted to at least one said input option unit.

9. The printer of claim 1, said output option unit being coupled with an input option unit positioned immediately below and adjacent to said base unit.

10. The printer of claim 1, at least one of said base unit and one said input option unit including a plurality of keying features for locating said one input option unit relative to said base unit.

11. The printer of claim 10, said plurality of keying features comprising a plurality of keying posts extending from said one input option unit.

12. The printer of claim 1, wherein said at least one input option unit comprises a plurality of input option units, at least one said input option unit comprising a media supply tray.

13. The printer of claim 1, said output option unit comprising at least one output option unit.

14. The printer of claim 1, wherein said output option unit comprises at least one of a stacker, stapler, hole puncher and offset jogger.

15. The printer of claim 1, said printer comprising one of an electrophotographic printer and an ink jet printer.

16. A printer for printing on a print medium, said printer comprising:
a base unit including a primary media supply tray;
an input option unit positioned below said primary media supply tray; and
an output option unit coupled with said input option unit.

17. The printer of claim 16, said input option unit comprising one of a plurality of input option media supply trays, said input option media supply trays arranged in a vertically stacked relationship to each other beneath said primary media supply tray.

18. The printer of claim 16, said base unit including a plurality of side walls, said output option unit positioned adjacent to one of said side walls.

19. The printer of claim 16, said output option unit coupled with said input option unit via a plurality of mounting beams.

20. The printer of claim 19, said mounting beams being one of detachably mounted and fixedly mounted to said output option unit.

21. The printer of claim 19, said mounting beams being one of detachably mounted and fixedly mounted to at least one said input option unit.

22. The printer of claim 16, at least one of said base unit and said input option unit including a plurality of keying features for locating said one input option unit relative to said base unit.

23. The printer of claim 22, said plurality of keying features comprising a plurality of keying posts extending from said one input option unit.

24. The printer of claim 16, wherein said input option unit comprises a plurality of input option units, at least one said input option unit comprising a media supply tray.

25. The printer of claim 16, said output option unit comprising at least one output option unit.

26. The printer of claim 16, wherein said output option unit comprises at least one of a stacker, stapler, hole puncher and offset jogger.

27. The printer of claim 16, said printer comprising one of an electrophotographic printer and an ink jet printer.

28. A method of assembling a printer for printing on a print medium, said method comprising the steps of:
providing a base unit, at least one input option unit and an output option unit;
coupling each said input option unit with at least one of said base unit and another said input option unit; and
coupling said output option unit with at least one said input option unit.

29. The method of assembly of claim 28, said base unit including a primary media supply tray, and said at least one input option unit comprising a plurality of media supply trays, and including the step of arranging said media supply trays in a vertically stacked relationship to each other beneath said primary media supply tray.

30. The method of assembly of claim 28, including the step of coupling said output option unit with at least one said input option unit using a plurality of mounting beams.

31. The method of assembly of claim 28, wherein said first coupling step comprises keying said input option unit to said base unit using a plurality of keying features for locating said one input option unit relative to said base unit.
